(19) United States
(12) Patent Application Publication
(10) Pub. No.: US 2014/0071399 A1
(43) Pub. Date: Mar. 13, 2014

(54) OPTICAL APPARATUS

(71) Applicant: Adaptive Spectacles Ltd., Milton Keynes (GB)

(72) Inventors: Christopher William WRAY, Buckinghamshire (GB); Joshua David Silver, Marsh Gibbon (GB)

(73) Assignee: Adaptive Spectacles Ltd., Milton Keynes (GB)

(21) Appl. No.: 14/019,756

(22) Filed: Sep. 6, 2013

(30) Foreign Application Priority Data
Sep. 7, 2012 (GB) 1216000.8

(51) Int. Cl. G02C 7/08; G02C 7/02

(52) U.S. Cl. CPC G02C 7/085; G02C 7/024
USPC 351/159.68; 351/159.74

(57) ABSTRACT

Optical apparatus comprises at least one variable power lens 1 formed by a fluid-filled cavity 2 defined between two transparent walls 3, 4, at least one of which is provided by a flexible membrane 4. The apparatus further comprises a first pump 10 in fluid communication with the cavity 2 for varying the volume of fluid in the cavity 2 in order to change the optical power of the lens 1. A second pump 20 is provided in fluid communication with the cavity 2 for varying the volume of fluid in the cavity 2 in order to change the optical power of the lens 1. The second pump 20 is in fluid communication with the cavity 2 via a detachable connection 7, so that the second pump 20 can be removed from the apparatus after adjustment of the optical power of the lens 1.

This invention relates to optical apparatus having at least one variable power lens, and in particular to spectacles having variable power lenses.

### BACKGROUND

It is known, for example from WO98/11458, to provide spectacles having variable power lenses. Such lenses are formed by a fluid-filled cavity defined between two transparent walls, at least one of which is provided by a flexible membrane. The power of the lens is varied by adjusting the volume of fluid in the cavity such that the flexible membrane deforms and changes the curvature of the surface of the lens. The volume of fluid within the cavity is typically adjusted by means of a pump, such as a syringe. Such spectacles have the advantage that the optical power of the spectacles may be adjusted to meet the requirements of the wearer.

It is desirable for the optical power of the lenses to be adjustable over a large range of power in order that the same model of spectacle can be used by as large a range of wearers as possible. However, for the adjustment range of the lens to be large, the volume of fluid that can be introduced or removed from the cavity by the pump must also be relatively large, resulting in a relatively large pump. It is undesirable, however, from an aesthetic perspective for spectacles to include a relatively large pump. For this reason, variable power spectacles are known in which the pump(s) can be detached from the spectacles once the power of the lenses has been set by the user. However, such spectacles cannot then subsequently be adjusted by the user.

The present invention, at least in its preferred embodiments, seeks to provide optical apparatus, such as spectacles, with variable power lenses having a large range of optical power and that can be adjusted continually by the wearer, in use, while maintaining an acceptable aesthetic appearance.

### BRIEF SUMMARY OF THE DISCLOSURE

In accordance with the present invention there is provided optical apparatus comprising at least one variable power lens formed by a fluid-filled cavity defined between two transparent walls, at least one of which is provided by a flexible membrane. The apparatus further comprises a first pump in fluid communication with the cavity for varying the volume of fluid in the cavity in order to change the optical power of the lens, and a second pump in fluid communication with the cavity for varying the volume of fluid in the cavity in order to change the optical power of the lens. The second pump is in fluid communication with the cavity via a detachable connection, whereby the second pump can be removed from the apparatus after adjustment of the optical power of the lens.

Thus, in accordance with the invention, the total range of adjustment of the power of the lens can be determined by the capacity of the second pump, which can be removed after initial adjustment, leaving the first pump to provide the facility of continual adjustment of the lens power. The capacity, configuration and dimensions of the first pump can be selected in order to achieve the desired aesthetic appearance without being limited by the pump capacity required to provide the necessary range of initial adjustment.

The optical apparatus may be a monocle, goggles or the like. In the preferred embodiment the optical apparatus is spectacles. Spectacles may include sunglasses. The spectacles typically comprise two variable power lenses. Each variable power lens may be provided with a respective first pump. Each variable power lens may be provided with a respective second pump. Feasibly, a single second pump may be provided for use with both lenses.

The fluid in the cavity is typically a liquid. The liquid may be selected to have the desired refractive index. Silicone oil is one possible fluid.

At least one of the transparent walls of the cavity is provided by the flexible membrane. The other wall may also be provided by a flexible membrane. Alternatively, the other wall may be provided by a rigid transparent material. The rigid material may be shaped to provide some lens power. The transparent materials of the or a wall may be tinted, if desired. The optical apparatus may comprise a rigid transparent cover for the or each flexible membrane. The transparent cover may provide rigidity to the lens structure and/or provide resistance to impact.

The flexible membrane may be formed of plastics material, for example polyester.

The first and/or second pump may be a syringe pump, a piston pump, a deformable bladder, a bellows or any other suitable form of pump. Desirably, an adjustment mechanism may be provided for the or each pump. The adjustment mechanism may comprise a worm screw, a ratchet, a rack and adjustment wheel or any other suitable mechanism.

The detachable connection may be provided by any suitable connector, for example a simple socket or luer connector. The detachable connection may be reconnectable so that the second pump can be reconnected to the cavity. Alternatively, the detachable connection may be a frangible connection, such that second pump is permanently disconnected from the cavity. As will be apparent, the first pump is intended to be connected permanently to the cavity.

The apparatus may comprise a valve provided between the cavity and the detachable connection for preventing the egress of fluid through the detachable connection when the second pump has been removed. Thus, the valve may be closed before the second pump is removed. The valve may be any suitable valve, such as a twist valve or a pinch valve, for example. Potentially, the valve may be provided by a septum. In this case, the detachable connection may be provided by a syringe needle.

In embodiments of the invention, the fluid capacity of the second pump is larger than the fluid capacity of the first pump. For example, the fluid capacity of the second pump may provide a range of adjustment of the lens between −5 dioptres and +3 dioptres. In embodiments of the invention the fluid capacity of the second pump may provide a range of adjustment of the lens of at least 6 dioptres, possible at least 4 dioptres, feasibly at least 3 dioptres or even at least 2 dioptres. The minimum power of the lens may be one of at least −5 dioptres, at least −4 dioptres, at least −3 dioptres, at least −2 dioptres, at least −1 dioptres, at least 0 dioptres, at least +1 dioptre. The maximum power of the lens may be one of less than +3 dioptres, less than +2 dioptres, less than +1 dioptres, less than 0 dioptres or less than −1 dioptre. The fluid capacity of the first pump may provide a range of adjustment of the lens of at least 1 dioptre, at least 2 dioptres or at least 3 dioptres in embodiments of the invention.

A typical lens has a minimum height of at least 30 mm and a minimum width of at least 50 mm The lens should not be more than about 5mm thick. It is possible for the area occupied by the cavity to be less than the total transparent area of the lens (the cavity may be provided within a transparent boundary member). Typically the volume of fluid in the cavity will be in the range 1 cc to 4 cc, for example 2 cc to 3 cc. The change in the volume of the fluid in the cavity may be in the range +/−1 cc.

The invention extends to spectacles comprising the optical apparatus. In the case of spectacles, the first pump may be provided within an arm of the spectacles.

Viewed from a further aspect there is provided a method of adjusting the optical power of the optical apparatus or spectacles of the invention. The method comprises using the second pump to set a desired initial optical power of the lens, removing the second pump and using the first pump, as necessary, to adjust subsequently the optical power of the lens.

### BRIEF DESCRIPTION OF THE DRAWINGS

Embodiments of the invention are further described hereinafter with reference to the accompanying drawings, in which:

FIG. 1 is a schematic representation of an optical apparatus according to an embodiment of the invention.

### DETAILED DESCRIPTION

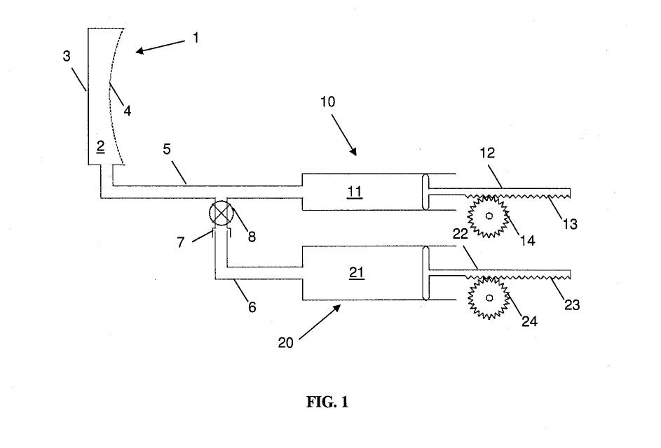

FIG. 1 shows schematically an optical apparatus according to an embodiment of the invention. The apparatus comprises a variable power lens 1 formed by a fluid-filled cavity 2 defined between two transparent walls 3, 4. One wall is provided by a flexible membrane 4, for example of plastics material. In this embodiment, the other wall 3 is provided by solid transparent material, such as plastics, and may be shaped to have itself some lens power. In alternative embodiments, both walls may be provided by flexible membranes.

The apparatus further comprises a first pump 10 in fluid communication with the cavity 2 for varying the volume of fluid in the cavity 2 in order to change the optical power of the lens 1. In this embodiment, the first pump 10 is in the form of a piston pump (or syringe) having a chamber 11 for containing fluid and a first plunger 12 received within the chamber 11 for increasing or decreasing the volume of the fluid in the chamber 11 whereby to decrease or increase the volume of fluid in the cavity 2. An increase in the volume of fluid in the cavity 2 flexes the membrane 4 outwardly and increases the power of the lens 1. A decrease in the volume of fluid in the cavity 2 flexes the membrane 4 inwardly (due to the effect of atmospheric pressure) and decreases the power of the lens 1. In this embodiment, the first plunger 12 is provided with a first rack 13, which engages a first toothed adjustment wheel 14. The user actuates the first pump by rotating the first adjustment wheel 14 to increase or decrease the volume of the fluid in the chamber 11, and thereby adjust the power of the lens 1.

The apparatus further comprises a second pump 20 in fluid communication with the cavity 2 for varying the volume of fluid in the cavity 2 in order to change the optical power of the lens 1. In this embodiment, the second pump 20 is in the form of a piston pump (or syringe) having a chamber 21 for containing fluid and a second plunger 22 received within the chamber 21 for increasing or decreasing the volume of the fluid in the chamber 21 whereby to decrease or increase the volume of fluid in the cavity 2. An increase in the volume of fluid in the cavity 2 flexes the membrane 4 outwardly and increases the power of the lens 1. A decrease in the volume of fluid in the cavity 2 flexes the membrane 4 inwardly (due to the effect of atmospheric pressure) and decreases the power of the lens 1. In this embodiment, the second plunger 22 is provided with a second rack 23, which engages a second toothed adjustment wheel 24. The user actuates the second pump by rotating the second adjustment wheel 24 to increase or decrease the volume of the fluid in the chamber 21, and thereby adjust the power of the lens 1.

The first pump 10 is in fluid communication with the cavity 2 via a fluid conduit 5. The second pump 20 is in fluid communication with the cavity 2 via the fluid conduit 5 and a further conduit 6. The further conduit 6 connects to the fluid conduit 5 via a detachable connector 7 and a valve 8. The detachable connector 7 allows the second pump 20 to be disconnected from the apparatus and removed and the valve 8 prevents egress of fluid through the detachable connector 7 when the second pump 20 has been removed.

In this embodiment, the volume of the second chamber 21 is larger than the volume of the first chamber 11. Thus, the capacity of the second pump 20 is greater than the capacity of the first pump 10. In use, with the valve 8 open, the second pump 20 is used to set the power of the lens 1 in a range between −5 dioptres and +3 dioptres. The valve 8 is then closed and the second pump 20 is then removed. Subsequently, the first pump 10 can be used to provide fine adjustment of the power of the lens 1, for example in the range +/−1 dioptre relative to the power set by the second pump 20.

In one application, the first pump 10 may be used to adjust the power of the lens to convert distance spectacles to reading spectacles, for example from a negative power to a positive power.

Where the optical apparatus is incorporated into spectacles, the first pump 10 can be incorporated into an arm of the spectacles, with the fluid conduit 5 connecting the first pump 10 to the lens 1 through the arm. The (larger) second pump 20 can be external to the arm of the spectacles as it can be removed once the initial power of the lens 1 has been set. Typically a respective first pump 10 is provided in each arm of the spectacles in fluid communication with a respective lens 1.

In summary, optical apparatus comprises at least one variable power lens 1 formed by a fluid-filled cavity 2 defined between two transparent walls 3, 4, at least one of which is provided by a flexible membrane 4. The apparatus further comprises a first pump 10 in fluid communication with the cavity 2 for varying the volume of fluid in the cavity 2 in order to change the optical power of the lens 1. A second pump 20 is provided in fluid communication with the cavity 2 for varying the volume of fluid in the cavity 2 in order to change the optical power of the lens 1. The second pump 20 is in fluid communication with the cavity 2 via a detachable connection 7, so that the second pump 20 can be removed from the apparatus after adjustment of the optical power of the lens 1.

Throughout the description and claims of this specification, the words “comprise” and “contain” and variations of them mean “including but not limited to”, and they are not intended to (and do not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

As disclosed herein, it is possible to provide spectacles with a range of adjustment between −2 dioptres and +2 dioptres that may be continually adjusted in use. Such spectacles may be converted, in use, between distance spectacles and reading spectacles (and back again), in other words, from a negative to a positive power. This in itself is believed to be novel and thus, viewed from a further aspect, the invention provides spectacles comprising at least one variable power lens formed by a fluid-filled cavity defined between two transparent walls, at least one of which is provided by a flexible membrane, and a pump within an arm of the spectacles and in fluid communication with the cavity for varying the volume of fluid in the cavity in order to change the optical power of the lens continually, in use, within the range −2 dioptres and +2 dioptres. Optionally, a second pump may be provided. The lower range of adjustment may be −1 dioptre. The upper range of adjustment may be +1 dioptre.

1. Optical apparatus comprising at least one variable power lens formed by a fluid-filled cavity defined between two transparent walls, at least one of which is provided by a flexible membrane, the apparatus further comprising:
a first pump in fluid communication with the cavity for varying the volume of fluid in the cavity in order to change the optical power of the lens; and
a second pump in fluid communication with the cavity for varying the volume of fluid in the cavity in order to change the optical power of the lens,
wherein the second pump is in fluid communication with the cavity via a detachable connection, whereby the second pump can be removed from the apparatus after adjustment of the optical power of the lens.

2. Optical apparatus as claimed in claim 1 comprising a valve provided between the cavity and the detachable connection for preventing the egress of fluid through the detachable connection when the second pump has been removed.

3. Optical apparatus as claimed in claim 1, wherein the fluid capacity of the second pump is larger than the fluid capacity of the first pump.

4. Spectacles comprising the optical apparatus of claim 1, wherein the first pump is provided within an arm of the spectacles.

5. A method of adjusting the optical power of the optical apparatus of claim 1, comprising:
using the second pump to set a desired initial optical power of the lens;
removing the second pump; and
using the first pump, as necessary, to adjust subsequently the optical power of the lens.

6. Spectacles as claimed in claim 4, wherein the optical apparatus comprises a valve provided between the cavity and the detachable connection for preventing the egress of fluid through the detachable connection when the second pump has been removed.

7. Spectacles as claimed in claim 4, wherein the fluid capacity of the second pump is larger than the fluid capacity of the first pump.
